(19) United States
(12) Patent Application Publication
(10) Pub. No.: US 2017/0334668 A1
(43) Pub. Date: Nov. 23, 2017

(54) DESTACKER FOR TRAYS

(71) Applicant: MULTIVAC Sepp Haggenmüller SE & Co. KG, Wolfertschwenden (DE)

(72) Inventors: Bernhard Fickler, Hawangen (DE); Lars Mörschner, Lauben (DE)

(21) Appl. No.: 15/595,736

(22) Filed: May 15, 2017

(30) Foreign Application Priority Data
May 18, 2016 (EP) 16 170 142.0

(51) Int. Cl. B65G 59/06; B65G 35/04; B65G 59/10; B65H 3/08

(52) U.S. Cl. CPC B65G 59/066; B65G 59/107; B65G 35/04; B65G 59/068; B65H 3/0883; B65G 59/10

(57) ABSTRACT

A destacking device comprising at least two destacking screws for singulating and destacking trays from a tray stack. Each destacking screw comprises a helix that may be a helical recess in an outer surface of the screw. The two destacking screws may have an identical direction of rotation. In one embodiment, the helix of each of the at least two destacking screws may grip and guide a respective side of a tray flange of the tray at a first contact point at the outer edge of the helix's upper side, and a second contact point at the outer edge of the helix's lower side. The destacking device may include guiding devices positioned on opposing the non-gripped and/or the gripped sides of the tray to guide the path of the tray in a vertical direction.

### CROSS-REFERENCE TO RELATED APPLICATIONS

This application claims priority to European Patent Application Number 16 170 142.0 filed May 18, 2016, to Bernhard Fickler and Lars Mörschner, currently pending, the entire disclosure of which is incorporated herein by reference.

### FIELD OF THE INVENTION

The present invention relates to a destacker for packaging trays, which in one embodiment may be used in a packaging process.

### BACKGROUND OF THE INVENTION

EP 1685047 A1 discloses a destacker with four destacking screws, each of them arranged on a corner when seen with respect to the container stack. With respect to the sides of the container stack, guide elements are provided on all sides. This structural design is disadvantageous insofar as it requires the high constructional outlay of four driven destacking screws, and insofar as the arrangement of the four destacking screws does not allow handling comparatively small containers or a row of closely spaced container stacks.

### SUMMARY OF THE INVENTION

It is the object of the present invention to provide a simplified destacker which is also suitable for use with small trays.

The destacker according to the present invention comprises destacking screws for singulating and destacking trays of a tray stack, each destacking screw comprising a helix configured as a helical recess. The invention is characterized in that two destacking screws that which have an identical direction of rotation and an identical direction of windings (viz. turns direction) are provided for a common tray stack. This allows handling of a row of juxtaposed tray stacks that are disposed in closely spaced relationship with one another, since the destacking screws are provided in two opposed rows and each of them centrally with respect to the tray stack to be destacked. This also allows destacking of much smaller trays in comparison with the destacker according to the prior art, where four destacking screws are provided on the four corners of each tray stack.

The two destacking screws are preferably arranged such that the tray can be gripped at two opposed sides and conveyed downwards.

According to a particularly advantageous embodiment, the helixes of both destacking screws have a contact height corresponding to a flange height of the tray flange, so as to allow form-fit holding and destacking of the trays in a particularly reliable manner. In one embodiment the contact height corresponds to a flange height of the tray flange, at least substantially (i.e. except for a deviation of not more than 5-10%). The contact height (or synonymously: the vertical contact distance) of the helixes is defined below.

Each helix may be a helically extending recess in the outer wall of a destacking screw. This helical recess has an approximately rectangular cross-section delimited by substantially horizontal upper and lower sides, an inner side extending parallel to the axis of rotation of the destacking screw, and an open outer side which is also parallel to said axis of rotation. The upper side of the helical recess merges at an upper outer edge with the usually cylindrical outer wall of the destacking screw; the lower side does so in a corresponding manner at a lower outer edge. When a virtual tangent plane may be now constructed to the inner side of the helical recess of the helix, said virtual tangent plane, which may be perpendicular to the radius of the destacking screw, will have a first point of intersection with the lower outer edge of the helix in the upward sloping direction of the helix, and a second point of intersection with the upper outer edge of the helix in the downward sloping direction of the helix.

The contact height (or synonymously: the vertical contact distance) may be defined as the distance between these two points of intersection projected onto the axial direction of the destacking screw. According to a particularly advantageous embodiment, the helix exhibits a constant vertical contact distance (contact height) between an upper side and a lower side of the helix, so that the tray may be guided at four points. A first side of the tray flange will here abut on an upper surface of the helix of the first destacking screw and the second side of the tray flange, which may be opposed to the first side, will abut on an upper surface of the helix of the second destacking screw. Likewise, the first side of the tray flange will abut on a lower surface of the helix of the first destacking screw and the second side of the tray flange, which may be opposed to the first side, will abut on a lower surface of the helix of the second destacking screw. The four guide points, which are arranged diagonally in space in this way, ensure horizontal forced guidance of the tray during the singulating process and during conveyance of a single tray in a downward direction. The contact height of the helix corresponds to the flange height of the tray so as to allow forced guidance by means of a form-fit engagement.

The destacking screws are preferably configured for guiding a respective side of the tray flange with a respective contact point with the outer edge of the upper side and of the lower side of their helixes, so that, during singulating using the two destacking screws arranged on opposed sides of the tray flange, a spatial four-point guidance will have the effect that the position of the tray may be determined by the position of the helixes of the two destacking screws.

Preferably, at least two guiding devices are arranged on the two opposed sides of the tray which are not gripped by the two destacking screws, said two guiding devices being vertically oriented and configured to guide a tray which has already been singulated and which leaves the destacking screws in a downward direction. This leads to an exact impingement position of the tray bottom of the tray on a conveying unit located therebelow, since, even without being still in contact with the destacking screws, the tray may be guided on at least two sides thereof and covers the remaining height with a vertically dropping movement, so that deviations from the desired impingement position will not exceed extremely small values.

The guiding devices project in a vertically downward direction beyond the lower ends of the helixes of the destacking screws preferably by at least 5 mm, so as to guarantee, even without the destacking screws, reliable guidance merely by the guiding devices themselves.

Additional guiding devices may be provided on the tray flange sides of the tray so as to improve the guidance behavior of the tray during the singulating process still further.

Other aspects and advantages of the present invention will be apparent from the following detailed description of the preferred embodiments and the accompanying drawing figures.

### DESCRIPTION OF THE SEVERAL VIEWS OF THE DRAWING

In the following, an advantageous embodiment of the present invention will be explained in more detail making reference to the following drawings, in which the individual figures show:

FIG. 1 is a schematic view of one embodiment of a destacker in accordance with the teachings of the present invention;

FIG. 2 is a perspective view of one embodiment of destacking screws of a destacker in accordance with the teachings of the present invention;

FIG. 3 is a top view of the embodiment of the destacking screws of FIG. 2;

FIG. 4 is a schematic sectional view of the embodiment of the destacking screws of FIG. 3 cut along the line A-A; and

FIG. 5 is a top view of one embodiment of destacking screws of a destacker in accordance with the teachings of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

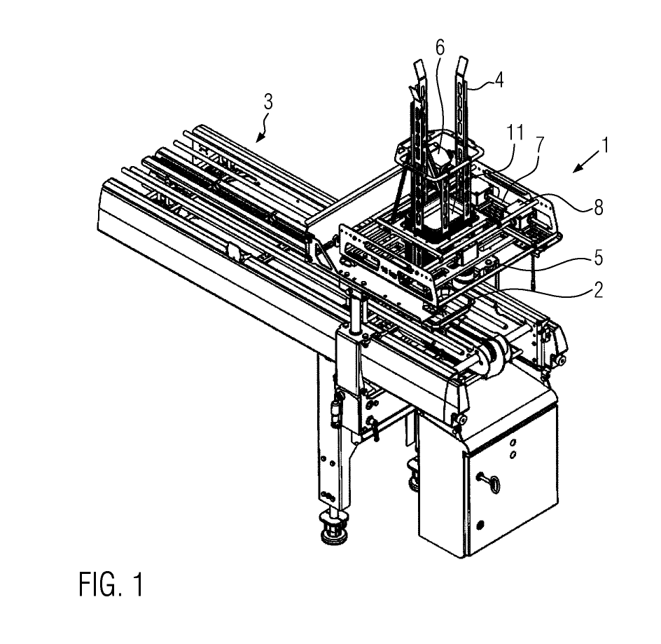

FIG. 1 shows a destacker 1 according to the present invention, which is configured for making prefabricated trays 2 drop separately onto a conveying unit 3, so as to feed the respective tray 2 subsequently to a filling station or an infeed station of a packaging machine. The destacker 1 comprises vertical guide elements 4 for receiving a tray stack 11. Two destacking screws 5 acting on the trays 2 are driven by a common motor 6, preferably a servomotor. The two destacking screws 5 are attached to a common gear shaft 7 by means of a gear unit 8 for each of the destacking screws 5, and they are displaceable along this gear shaft 7 so as to be adaptable to different tray sizes.

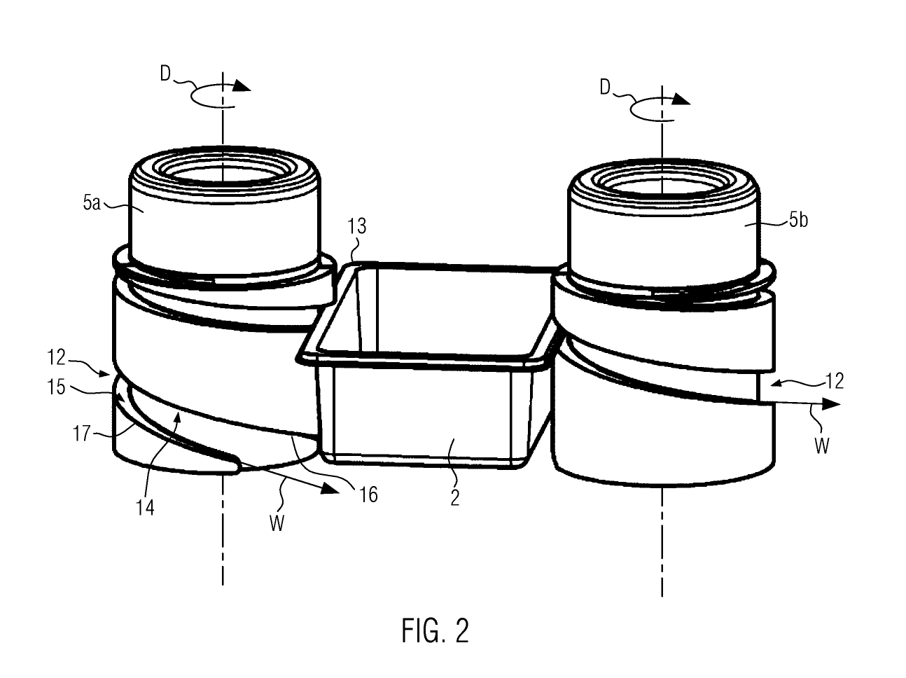

FIG. 2 shows a perspective view of the two destacking screws 5a and 5b, which both have the same direction of rotation D, shown in the embodiment of FIG. 2 in a clockwise direction. Each destacking screw 5a, 5b comprises a helix 12 configured as a helical recess. The winding direction W of the helixes is identical in the case of both destacking screws 5a, 5b so as to convey the tray 2 downwards. The winding direction W is defined by the downward slope in the case of a clockwise direction of rotation D. The tray 2 is received by the destacking screws 5a, 5b in the helix 12 at opposed sides of a tray flange 13 of the tray 2. The helix 12 has an upper side 14 and a lower side 15 as well as an upper outer edge 16 and a lower outer edge 17.

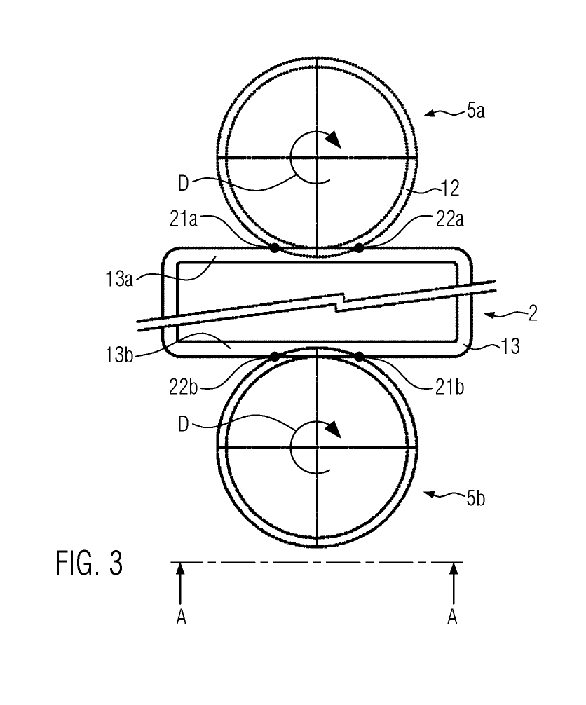

FIG. 3 shows a top view of the destacking screws 5a, 5b, the tray 2 being received by the helixes 12 of the two destacking screws 5a, 5b between destacking screw 5a, graphically shown at the top in a dotted-line representation, and destacking screw 5b, graphically shown at the bottom by a dot-and-dash line, and being moved into the plane of projection by a rotation in the direction of rotation D of the destacking screws 5a, 5b. The circumferentially extending tray flange 13 of the tray 2 is in contact with two respective points of contact at the outer edges 16, 17 of the upper side 14 and of the lower side 15 of the respective helix 12 of the destacking screws 5a, 5b, as shown in FIG. 2.

The first tray flange side 13a of the tray 2, which is disposed at the top in the drawing, is in contact with the lower side 15 of the first destacking screw 5a on the outer edge 17 at a first contact point 21a, located on the left hand side in the drawing, and with the upper side 14 of the first destacking screw 5a on the outer edge 16 at a second contact point 22a located on the right hand side of the drawing. Analogously, the second tray flange side 13b of the tray 2 (seen at the bottom in the drawing) is in contact with the lower side 15 of the second destacking screw 5b on the outer edge 17 at a first contact point 21b, located on the right hand side in the drawing, and with the upper side 14 of the second destacking screw 5b on the outer edge 16 at a second contact point 22b located on the left hand side of the drawing.

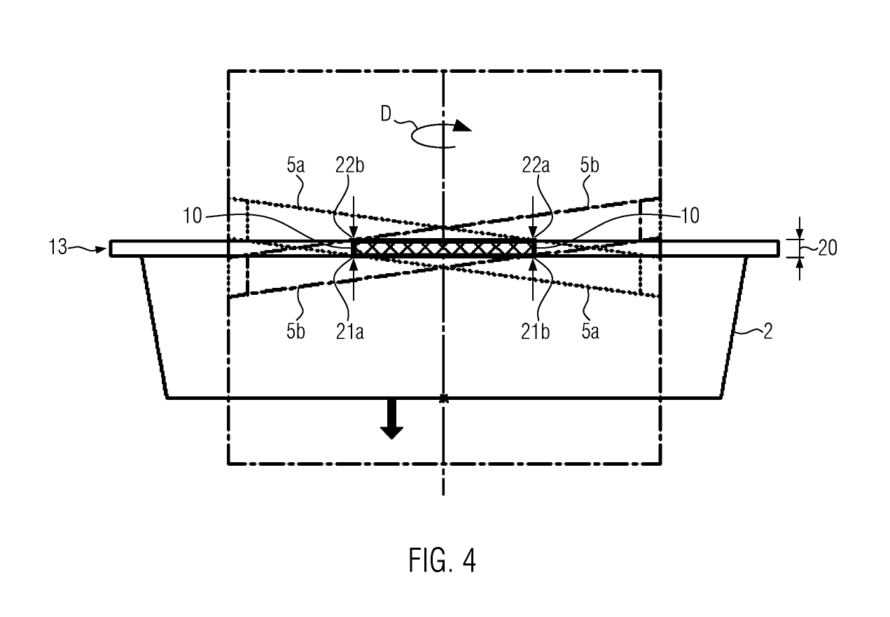

In FIG. 4, the four contact points 21a, 22a, 21b and 22b are shown once more in a view A-A of FIG. 3, each of the destacking screws 5a, 5b being here shown with only one helix section. For the sake of clarity, the helix 12 of the first destacking screw 5a is shown in a dotted-line representation and the helix 12 of the second destacking screw 5b is shown by a dot-and-dash line. The rotation D of the destacking screws 5a, 5b shown in FIG. 3 has the effect that the tray 2 moves downwards in the direction of the arrow. During this movement, the tray 2 is reliably held on its flange 13 at the respective outer edges 16, 17 of the upper side 14 and of the lower side 15 of both helixes 12, i.e. at four points, and guided downwards. A diagonal or crosswise form fit is provided.

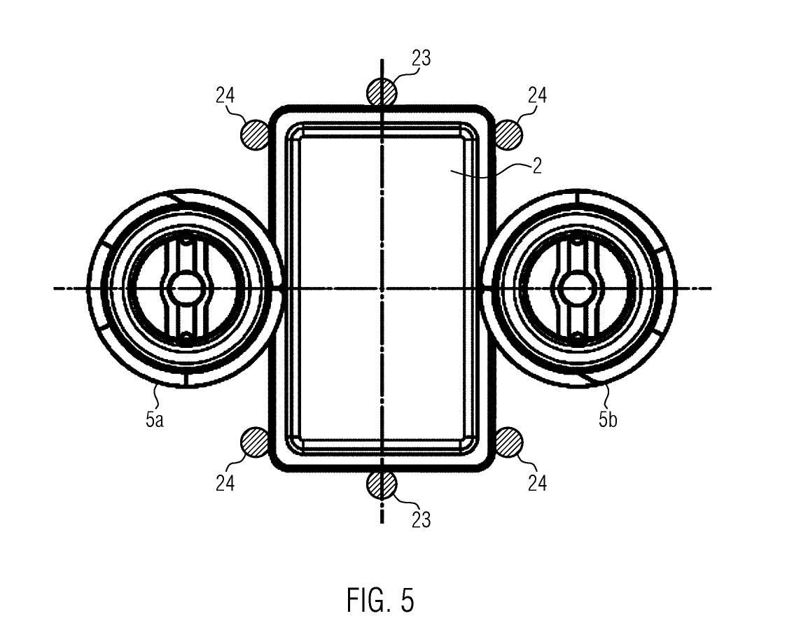

In order to prevent the tray 2 from rotating still further, guiding devices 23 are provided (see FIG. 5). When the slope of the helix 12 changes, the tray 2 is guided reliably until it leaves the helix 12 at the lower end of the destacking screws 5a, 5b.

FIG. 4 shows also the flange height 20 of the tray flange 13 and the contact height 10 of the two helixes 12, the contact height 10 corresponding to the flange height 20 of the tray 2. When FIGS. 3 and 4 are taken into account in combination, it can additionally be seen how the contact height (i.e. the vertical contact distance) is defined. In FIG. 3, the tray flange portion 13a of the tray 2 abuts on the inner side of the helix 12 of the destacking screw 5a. Hence, a virtual tangent plane is defined, which, on the one hand, is parallel to the axis of rotation of the destacking screw 5a and, on the other hand, includes the outer edge of the tray flange portion 13a, when the tray flange abuts on the inner side of the helix 12.

As shown in FIGS. 3 and 4, two points of intersection with the tangent plane with the helix 12 are obtained. A point of intersection 21a with the outer edge of the upward sloping part of the helix 12 (i.e. in the direction of rotation D of the destacking screw, starting from the point of intersection of the helix inner side with the virtual tangent plane) is defined, and, on the other hand, a further point of intersection 22a with the outer edge 16 of the downward sloping part of the helix is defined (i.e. opposite to the direction of rotation D of the destacking screw, starting from the point of intersection of the helix inner side with the virtual tangent plane). The vertical distance between these two contact points, projected onto the direction of the axis of rotation of the destacking screw 5a (see FIG. 4), is the contact height. In FIG. 4 it can be seen that this contact height may substantially correspond to the flange height 20 of the tray 2.

FIG. 5 shows a top view of the destacker 1 with vertically oriented guiding devices 23 in the form of round rods on the sides of the tray flange 13 that are not in contact with the destacking screws 5a, 5b. Additional guiding devices 24 on the other tray flange sides 13a, 13b are also within the scope of the present destacker.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions and methods described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms is “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A tray destacker comprising:
at least two destacking screws for singulating and destacking a tray from a tray stack;
wherein each of the at least two destacking screws comprise a helix configured as a helical recess; and
wherein the at least two destacking screws have an identical direction of rotation and an identical direction of winding.

2. The tray destacker according to claim 1, wherein the at least two destacking screws are disposed to grip the tray at two opposing sides of a tray flange of the tray and to convey the tray in a downward direction.

3. The tray destacker according to claim 1, wherein the helix of each of the at least two destacking screws has a contact height substantially corresponding to a flange height of a tray flange of the tray.

4. The tray destacker according to claim 3, wherein the contact height allows the helical recess to receive the tray flange of the tray and guide the tray flange between an outer edge of the upper side and an outer edge of the lower side of the helix of each of the at least two destacking screws.

5. The tray destacker according to claim 1, wherein the helix of each of the at least two destacking screws is configured for guiding a respective side of a tray flange of the tray with a first contact point at the outer edge of the upper side of the helix, and a second contact point with the lower side of the helix.

6. The tray destacker according to claim 2, further comprising at least two guiding devices disposed on the two opposing sides of the tray that are not gripped by the at least two destacking screws, wherein said two guiding devices are vertically oriented and disposed for guiding the vertical movement of the tray after the tray has been singulated or has disengaged the at least two destacking screws.

7. The tray destacker according to claim 6, wherein the two guiding devices project in a vertically downward direction beyond a lower end of the helix of each of the at least two destacking screws.

8. The tray destacker according to claim 7, wherein the two guiding devices project in a vertically downward direction beyond a lower end of the helix of each of the at least two destacking screws by at least 5 mm.

9. The tray destacker according to claim 6 further comprising one or more additional guiding devices provided on the sides of the tray that are gripped by the destacking screws.
